(19) United States
(12) Patent Application Publication
(10) Pub. No.: US 2026/0153113 A1
(43) Pub. Date: Jun. 4, 2026

(54) RIVET ASSEMBLY

(71) Applicant: KING POINT ENTERPRISE CO., LTD., Kaohsiung City (TW)

(72) Inventor: Wen Pin HUANG, Kaohsiung City (TW)

(73) Assignee: KING POINT ENTERPRISE CO., LTD., Kaohsiung City (TW)

(21) Appl. No.: 18/965,477

(22) Filed: Dec. 2, 2024

(51) Int. Cl. F16B 19/10

(52) U.S. Cl. CPC F16B 19/1045

(57) ABSTRACT

A rivet assembly configured to rivet an object to be riveted has a mandrel and a rivet body sleeved on the mandrel. The mandrel has a mandrel head and a mandrel shank having a pull section at an end of the mandrel shank. The pull section has a reverse taper with a reverse tapered surface tapering toward the mandrel head. Multiple engaging grooves arranged along the axial direction at spaced intervals are formed in the reverse tapered surface to form multiple engaging rings therebetween with diameter differences. The pull section of the mandrel may provide a larger gripping area. The gripping force applied to the engaging rings with non-uniform diameters of the pull section via a pull fixture is distributed concentrically. The pull section can be stably and firmly gripped by the pull fixture accordingly.

### BACKGROUND OF THE INVENTION

### 1. Field of the Invention

The present invention relates to a rivet assembly, and more particularly to a rivet assembly having a reverse tapered surface.

### 2. Description of Related Art

A conventional rivet assembly is configured for riveting multiple workpieces and comprises a rigid mandrel and a rivet body being deformable by pressing. The mandrel has a mandrel shank and a mandrel head at an end of the mandrel shank. The mandrel has a pull section formed at the other end of the mandrel. The rivet body surrounds the mandrel. The rivet assembly is inserted into a through hole formed through multiple stacked workpieces. The rivet body is subjected to stress from one side or stresses from two sides of the stacked workpieces and deforms to rivet the stacked workpieces.

The stacked workpieces can be riveted with each other via the conventional rivet assembly. However, in the conventional rivet assembly, the pull section of the mandrel configured to be gripped by an operating tool is a straight rod with a uniform diameter. The pull section has multiple engaging teeth formed at a peripheral surface thereof to be gripped by the operating tool. Since depths of the engaging teeth are shallow, a gripping area provided by the pull section of the conventional rivet assembly is relatively small. Whereby, the operating tool is prone to slip off from the pull section of the mandrel when a force is applied by the operating tool to grip the pull section. The riveting process is difficult to complete accordingly. In order to provide a sufficient gripping force between the conventional rivet assembly and the operating tool while pulling the mandrel, a length of the pull section of the mandrel needs to be increased to increase the grapping area of the pull section of the mandrel, thereby increasing the gripping force.

Since the pull section of the mandrel is longer, the overall length of the conventional rivet assembly increases, thereby increasing the manufacturing cost of the conventional rivet assembly. Moreover, since the pull section of the mandrel is longer, an engaging length between the operation tool and the pull section increases accordingly. As the result, the operation tool is difficult to engage with or to detach from the pull section.

To overcome the shortcomings, the present invention tends to provide a rivet assembly to mitigate or obviate the aforementioned problems.

### SUMMARY OF THE INVENTION

The main objective of the invention is to provide a rivet assembly having a reverse tapered surface to improve the shortcomings of the high manufacturing costs and the inconvenience to control the operating tool to grip with and to detach from the pull section of the conventional rivet assembly with a longer mandrel.

A rivet assembly is configured to rivet an object to be riveted and comprises a mandrel and a rivet body. The mandrel comprises a mandrel head, and a mandrel shank extending from an end of the mandrel head along an axial direction. The mandrel shank has a joining section and a pull section located at an end of the mandrel shank away from the mandrel head. The pull section has a reverse taper with a reverse tapered surface tapering from an end of the pull section toward the joining section and multiple engaging grooves radially formed in the reverse tapered surface of the reverse taper and arranged along the axial direction at spaced intervals to form multiple engaging rings therebetween. Adjacent two engaging rings formed besides each one of the multiple engaging grooves have a diameter difference. The rivet body is configured to be sleeved on the mandrel and comprises a rivet head, a rivet tube extending from an end of the rivet head, and an axial hole axially formed through the rivet head and the rivet tube of the rivet body. A diameter of the rivet tube is smaller than a diameter of the rivet head and is equal to or smaller than a diameter of the mandrel head of the mandrel. The joining section of the mandrel is configured to be inserted within the axial hole of the rivet body. The pull section of the mandrel is configured to extend out of the rivet body. The rivet tube of the rivet body is configured to face toward the mandrel head of the mandrel. The rivet body is configured to deform while subjecting to a stress for riveting the object to be riveted.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of an embodiment of a rivet assembly in accordance with the present invention;

FIG. 2 is a plan view of the rivet assembly in FIG. 1;

FIG. 3 is another plan view of the rivet assembly in FIG. 1;

FIG. 4 is an operational schematic view of a drilling step and shows drilling an object to be riveted;

FIG. 5 is an operational schematic view of a preassembling step and shows inserting a mandrel into a tube body of the rivet assembly in FIG. 1;

FIG. 6 is an operational schematic view of an installing step and shows inserting a mandrel of the rivet assembly in FIG. 1 into the object to be riveted;

FIG. 7 is an operational schematic view of a gripping step and shows gripping the mandrel of the rivet assembly in FIG. 1 with a pull fixture surrounded by a pull sleeve;

FIG. 8A is an operational schematic view of a pulling step and shows riveting the object to be riveted via the rivet assembly in FIG. 1;

FIG. 8B is another operational schematic view of the pulling step and shows riveting the object to be riveted via the rivet assembly in FIG. 1;

FIG. 9 is a perspective view in partial section and shows that the object to be riveted has been riveted by the rivet assembly in FIG. 1;

FIG. 10 is a plan view showing the object riveted by the rivet assembly in FIG. 1; and

FIG. 11 is a cross-sectional side view of the object riveted by the rivet assembly in FIG. 1 across line 11-11 in FIG. 10.

### DETAILED DESCRIPTION OF PREFERRED EMBODIMENTS

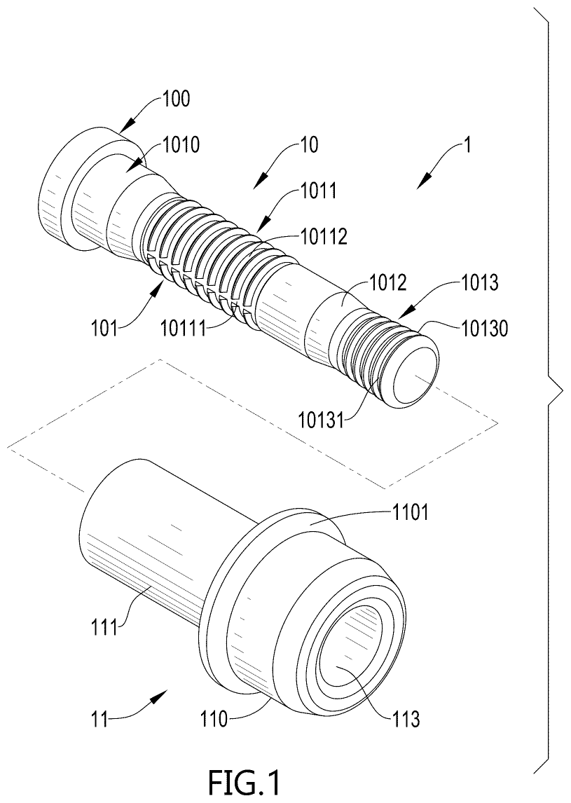

With reference to FIG. 1, an embodiment of a rivet assembly 1 having a reverse tapered surface in accordance with the present invention is configured to rivet an object to be riveted, which may comprise multiple workpieces stacked with each other. The rivet assembly 1 comprises a mandrel 10 and a rivet body 11. The mandrel 10 is a rigid part made of a metallic material. The rivet body 11 is made of a metallic material and able to be pressed to deform.

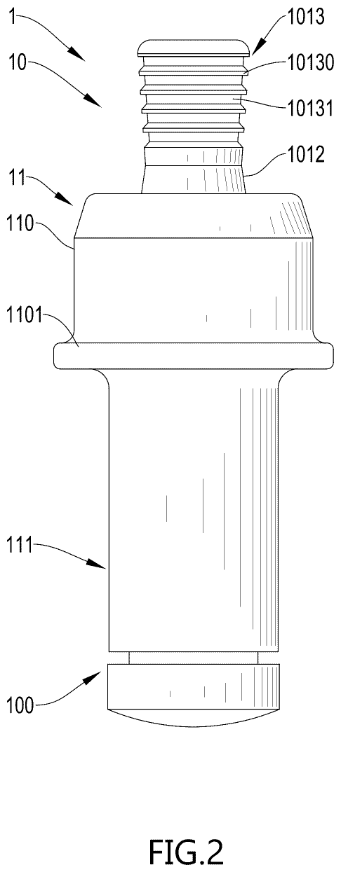

With reference to FIGS. 1 to 3, the mandrel 10 comprises a mandrel head 100 and a mandrel shank 101 extending from an end of the mandrel head 100 along an axial direction. A diameter of the mandrel head 100 is larger than a diameter of the mandrel shank 101.

With reference to FIGS. 1 to 3, the mandrel shank 101 comprises a joining section 1011 and a pull section 1013. A diameter of the joining section 1011 is smaller than the diameter of the mandrel head 100. The pull section 1013 is located at an end of the mandrel shank 101 away from the mandrel head 100, and has a reverse taper with a reverse tapered surface. That is, the pull section 1013 has a conical body tapering from an end of the pull section 1013 toward the joining section 1011. A diameter h of an inner end of the pull section 1013 facing toward the joining section 1011 is smaller than a diameter of an outer end of the pull section 1013 facing away from the joining section 1011 and is smaller than a diameter D of the joining section 1011. Specifically, a taper angle α formed between diametrically opposite sides of the reverse tapered surface of the pull section 1013 ranges from 6° to 24°, so the pull section 1013 is easily connected with and separated from a pull fixture.

With reference FIGS. 1 to 3, multiple engaging grooves 10131 are radially formed in the reverse tapered surface of the reverse taper of the pull section 1013 and are arranged along the axial direction at spaced intervals to form multiple engaging rings 10130 therebetween. Each engaging groove 10131 is located between two of the engaging rings 10130 axially adjacent to each other. Since the pull section 1013 has the reserve taper, adjacent two engaging rings 10130 formed besides each one of the multiple engaging grooves 10131 have a diameter difference.

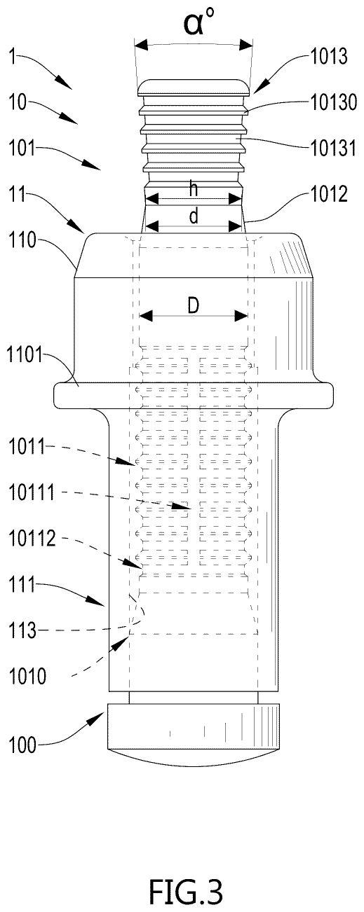

With reference to FIG. 3, a neck section 1012 is formed between the joining section 1011 and the pull section 1013 of the mandrel 10. The neck section 1012 is conical and tapers from the joining section 1011 toward the pull section 1013. A minor diameter d of the neck section 1012 is smaller than the diameter D of the joining section 1011 and is substantially equal to a diameter h of the end of the pull section 1013 facing toward the joining section 1011 to reduce interference of gripping the pull section 1013 with the reverse tapered surface by a pull fixture. In the embodiment, the minor diameter d of the neck section 1012 is larger than ⅞ times the diameter D of the joining section 1011 and is smaller than the diameter D of the joining section 1011.

With reference to FIGS. 1 to 3, the rivet body 11 has an axial hole 113 formed through the rivet body 11. The rivet body 11 is configured to be sleeved on the joining section 1011 of the mandrel 10, and the pull section 1013 is configured to extend out of the rivet body 11.

With reference to FIGS. 1 to 3, multiple annular grooves 10112 are radially formed in a peripheral surface of the joining section 1011 and are arranged at spaced intervals. At least one axial groove 10111 is parallel to the axial direction of the mandrel shank 101, is formed in the peripheral surface of the joining section 1011, and extends through and communicates with the multiple annular grooves 10112. A bottom of the axial groove 10111 is adjacent to or reaches bottoms of the annular grooves 10112. Therefore, the axial groove 10111 can function as an air exhaust channel.

With reference to FIGS. 1 to 3, the rivet assembly 1 is suitable for a unidirectional operation. The diameter of the mandrel head 100 of the mandrel 10 is smaller than a diameter of a bore formed through the objected to be riveted. The rivet body 11 comprises a rivet head 110 and a rivet tube 111 axially extending from an end of the rivet head 110. A diameter of the rivet tube 111 is smaller than a diameter of the rivet head 110. The axial hole 113 is formed through the rivet head 110 and the rivet tube 111. The rivet body 11 is configured to be sleeved on the mandrel 10. The diameter of the rivet tube 111 of the rivet body 11 is equal to or smaller than the diameter of the mandrel head 100, so the mandrel head 100 and the rivet tube 111 may be inserted through the bore of the object to be riveted from a front side thereof to extend the mandrel head 100 and a part of the rivet tube 111 out of a rear side of the object to be riveted. The mandrel head 100 is located at the front side of the object to be rivet.

In the embodiment, the rivet head 110 has an annular flange 1101 radially formed to an end of the rivet head 110 facing toward the rivet tube 111 to increase an abutting area between the rivet head 110 and the object to be riveted. Preferably, a diameter of the annular flange 1101 ranges from 1.05 times to 1.3 times the diameter of the rivet head 110. A length of the annular flange 1101 ranges from 0.1 times to 0.3 times an overall length of the rivet head 110. Therefore, the rivet head 110 is good at stress dispersing to reduce stress applied to the object to be riveted by a tool during riveting without increasing material costs.

With reference to FIGS. 1 to 3, a fixing section 1010 is formed between the joining section 1011 and a mandrel head 100. A diameter of the fixing section 1010 is smaller than the diameter of the mandrel head 100 and is larger than the diameter of the joining section 1011. The fixing section 1010 corresponds to the axial hole 113 of the rivet body 11 in size. A tapered portion is formed between the fixing section 1010 and the joining section 1011 and tapers from the fixing section 1010 toward the joining section 1011.

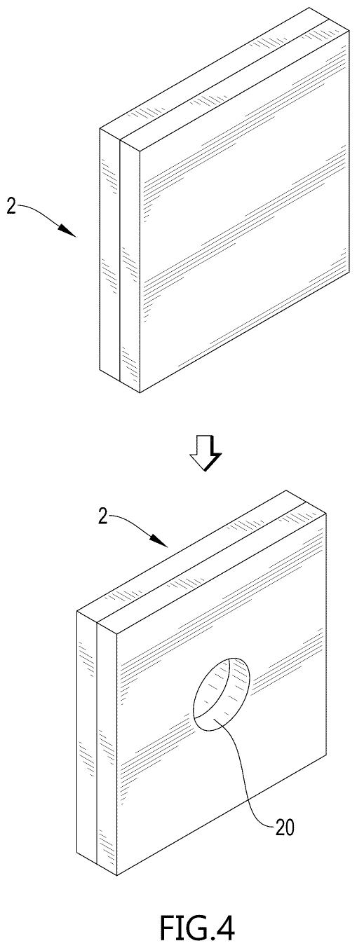

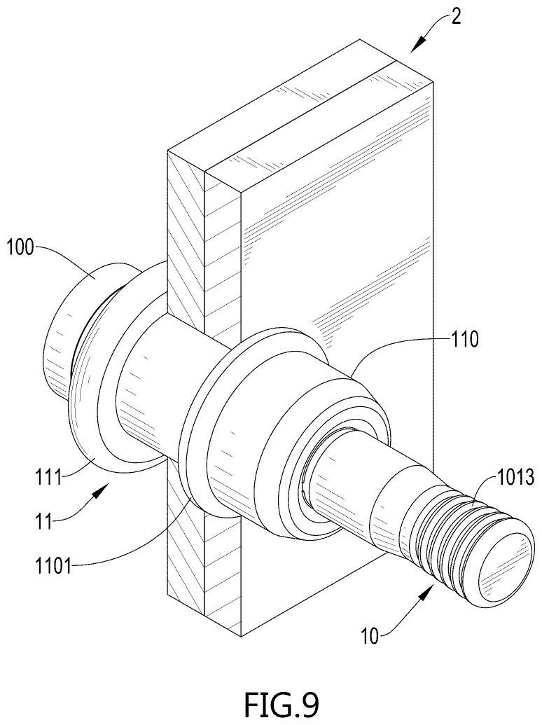

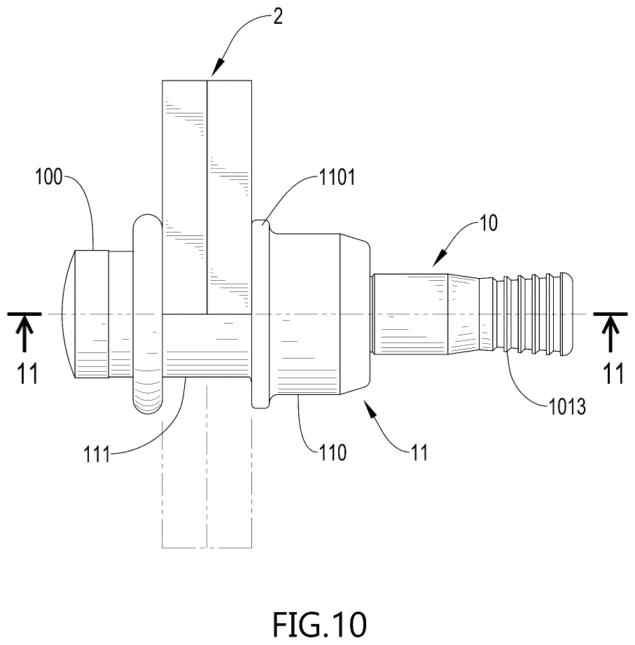

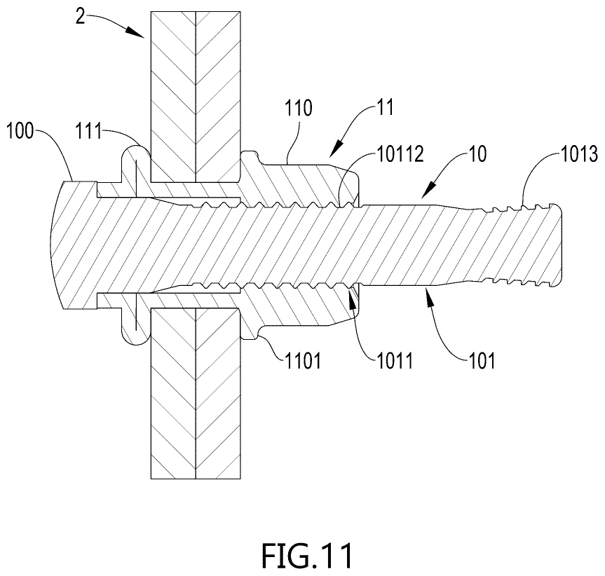

An assembly direction of the rivet assembly 1 can be adjusted according to a stacking direction of the multiple workpieces of the object to be riveted. For example, when the multiple workpieces of the object to be riveted are stacked transversally, the rivet assembly 1 is assembled transversally. When the multiple workpieces of the object to be riveted are stacked vertically, the rivet assembly 1 is assembled vertically from down to top or from top to down. With reference to FIGS. 4 to 11, the rivet assembly 1 transversally fastens the object to be riveted. A method for riveting the object to be riveted via the rivet assembly 1 includes a drilling step, a preassembling step, an installing step, a gripping step, and a pulling step.

With reference to FIGS. 3 and 4, in the drilling step, a bore 20 is drilled through the multiple workpieces of the object to be riveted 2. A diameter of the bore 20 can be adjusted according to actual requirement and a size of the rivet assembly 1. The diameter of the bore 20 is slightly larger than the diameter of the mandrel head 100 of the mandrel 10, is slightly larger than the diameter of the rivet tube 111 of the rivet body 11, and is smaller than the diameter of the rivet head 110.

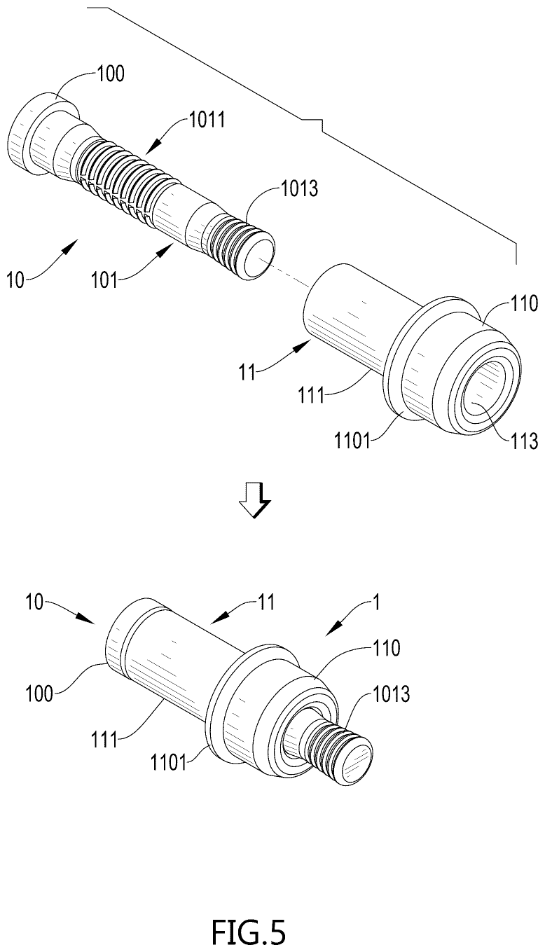

As shown in FIG. 5, in the preassembling step, the mandrel 10 of the rivet assembly 1 is inserted in the rivet body 11. Wherein, the rivet body 11 is sleeved on the joining section 1011 of the mandrel 10. The rivet tube 111 faces toward the mandrel head 100 of the mandrel 10. An end of the rivet tube 111 abuts against the mandrel head 100 of the mandrel 10, and the pull section 1013 of the mandrel 10 extends out of the rivet head 110.

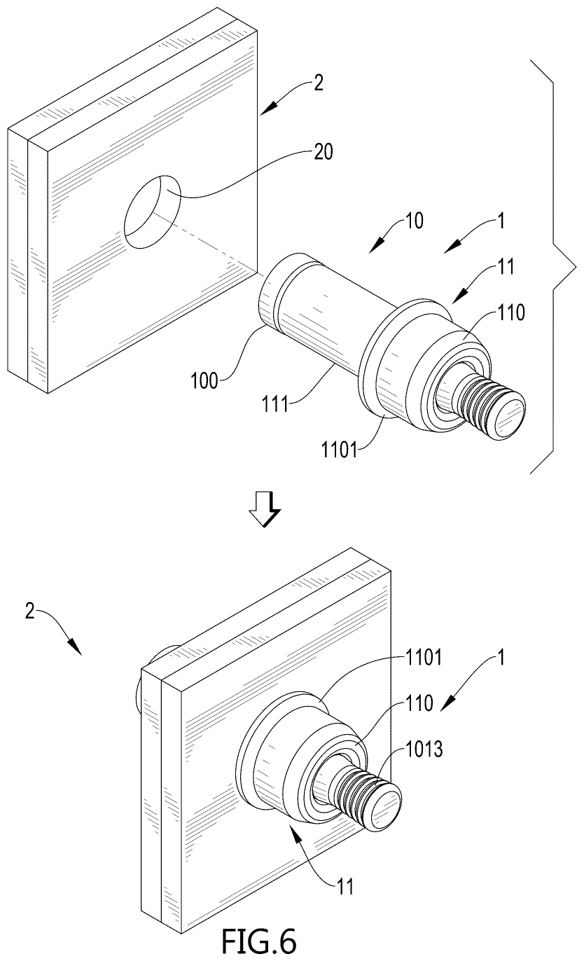

As shown in FIG. 6, in the installing step, the assembled rivet assembly 1 is inserted through the bore 20 from the front side of the object to be riveted 2 until the mandrel head 100 of the mandrel 10 and a part of the rivet tube 111 extends out of the rear side of the object to be riveted 2 and the annular flange 1101 of the rivet head 110 of the rivet body 11 abuts against the front side of the object to be riveted 2. The pull section 1013 of the mandrel 10 extends out of the rivet head 110.

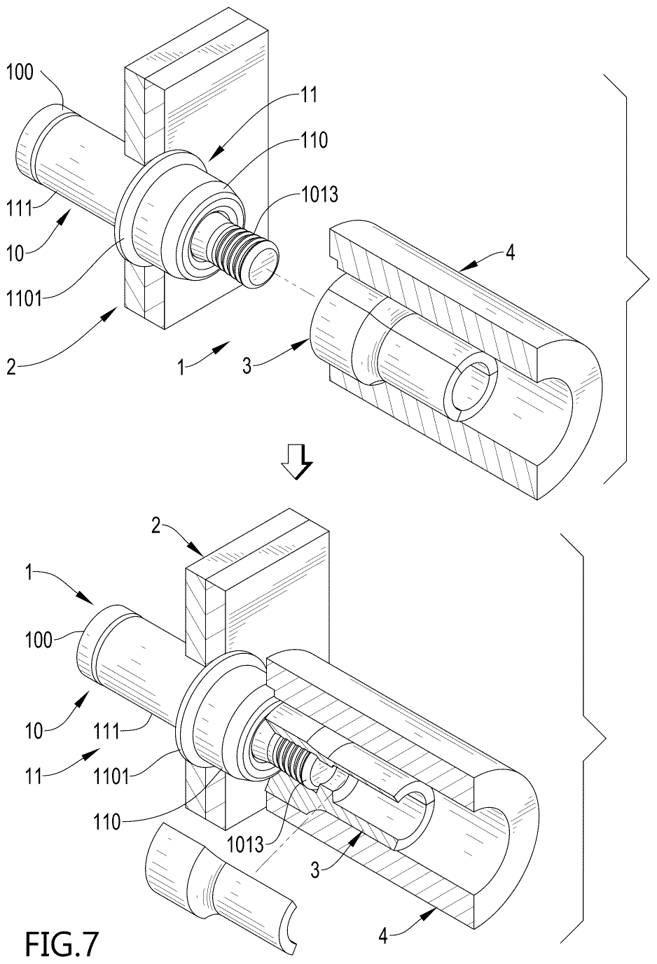

As shown in FIG. 7, in the gripping step, the pull section 1013 of the mandrel 10 is gripped by a pull fixture 3. A pull sleeve 4 is sleeved on the pull fixture 3 and abuts against the end of the rivet head 110 of the rivet body 11.

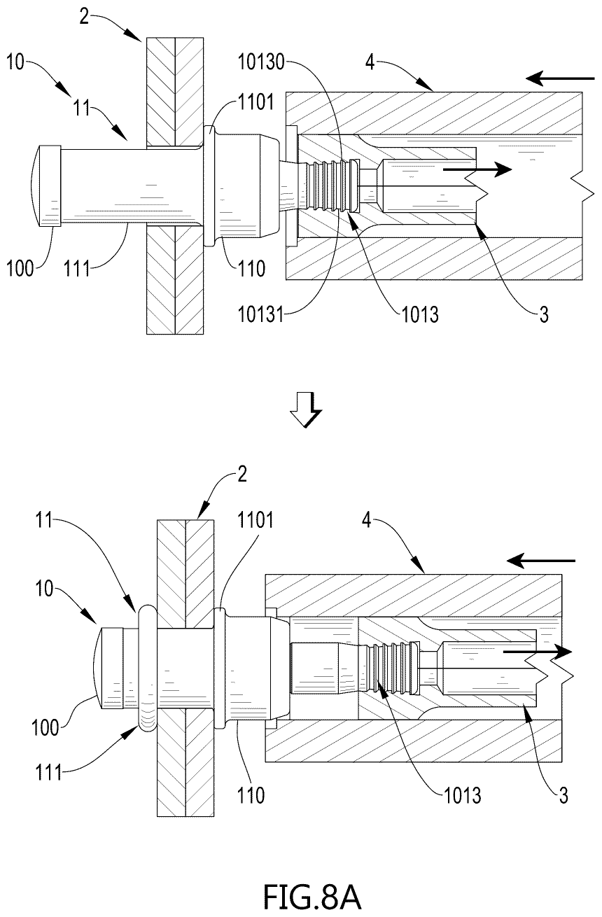

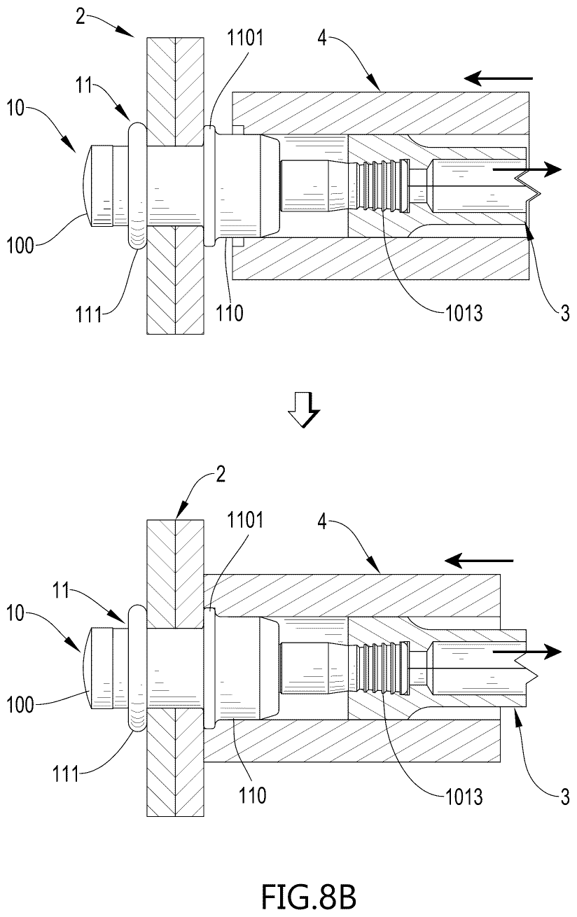

With reference to FIGS. 8A and 8B, in the pulling step, the rivet head 110 is secured and is subjected to an axial force toward the object to be riveted 2 via the pull sleeve 4. At the same time, the pull section 1013 of the mandrel 10 is gripped by the pull fixture 3 and is subjected to a force away from the object to be riveted 2. Since the rivet tube 111 of the rivet body 11 is thinner and the annular flange 1101 of the rivet head 110 having a larger diameter abuts against the side of the object to riveted 2, when the rivet body 11 is compressed, the rear pat of the rivet tube 111 of the rivet body 11 is pressed by the mandrel head 100 moving forward, deforms to form a radially expanding protrusion at the rear side of the object to be riveted 2. Said protrusion and the annular flange 1101 respectively abut against the opposite two sides of the object to be riveted 2 to clamp the object to be riveted 2. After that, the rivet head 110 of the rivet body 11 is subjected to an axial stress via the pull sleeve 4 and deforms. Wherein, when the rivet head 110 deforms via strain effects, the rivet head 110 and the joining section 1011 of the mandrel 10 are tightly joined together. The object to be riveted 2 is clamped at the opposite two sides thereof to fasten the multiple workpieces.

With reference to FIGS. 7, 8A, and 8B, in the pulling step, the pull fixture 3 may comprise a set of three assembling parts. An engagement structure is formed at an inner surface of each assembling part to engage with the engaging grooves 10131 of the pull section 1013, so the pull fixture 3 can grip the pull section 1013 of the mandrel 10. The pull sleeve 4 is a hollow part. The pull fixture 3 is configured to be mounted in the pull sleeve 4. The pull sleeve 4 is configured to apply a push force to the rivet head 110. The pull fixture 3 is configured to apply a pull force to the mandrel 10.

With reference to FIGS. 8A, 8B, and 9 to 11, the pull section 1013 of the present invention has the reverse taper with the reverse tapered surface. In the pull step, the pull section 1013 with reversed tapered surface provides a larger gripping area to be gripped than the conventional pull section being cylindrical and with a uniform diameter without elongating the pull section 1013

Moreover, since the engaging grooves 10131 are formed in the reverse tapered surface of the reverse taper of the pull section 1013, the multiple engaging rings 10130 with diameter differences are provided to increase the gripping area. Therefore, when the pull section 1013 of the mandrel 10 gripped by the pull fixture 3 is pulled, a larger and sufficient gripping force is applied therebetween because of the larger gripping area.

Furthermore, the pull fixture 3 engages with the multiple engaging grooves 10131 at various positions of the pull section 1013, the gripping force applied to the engaging rings 10130 with non-diameter diameters of the pull section 1013 via the pull fixture 3 is distributed concentrically. The pull fixture 3 may stably and firmly grip the pull section 1013 for applying force to the pull section 1013. Accordingly, the strain caused by pulling the mandrel 10 via the pull fixture 3 and applying stress to the rivet head 110 of the rivet body 11 via the pull sleeve 4 may be enhanced.

What is claimed is:

1. A rivet assembly configured to rivet an object to be riveted and comprising:
a mandrel comprising
a mandrel head;
a mandrel shank extending from an end of the mandrel head along an axial direction and having
a joining section;
a pull section located at an end of the mandrel shank away from the mandrel head and having a reverse taper with a reverse tapered surface tapering from an end of the pull section toward the joining section;
multiple engaging grooves radially formed in the reverse tapered surface of the reverse taper and arranged along the axial direction at spaced intervals to form multiple engaging rings between the multiple engaging grooves; and
adjacent two of the engaging rings formed besides each one of the multiple engaging grooves having a diameter difference; and
a rivet body configured to be sleeved on the mandrel and comprising
a rivet head; and
a rivet tube extending from an end of the rivet head;
an axial hole axially formed through the rivet head and the rivet tube of the rivet body; and
a diameter of the rivet tube being smaller than a diameter of the rivet head and being equal to or smaller than a diameter of the mandrel head of the mandrel; wherein
the joining section of the mandrel is configured to be inserted within the axial hole of the rivet body;
the pull section of the mandrel is configured to extend out of the rivet body;
the rivet tube of the rivet body is configured to face toward the mandrel head of the mandrel;
the rivet body is configured to deform while subjecting to a stress for riveting the object to be riveted.

2. The rivet assembly as claimed in claim 1, wherein
multiple annular grooves are radially formed in a peripheral surface of the joining section and are arranged at spaced intervals; and
at least one axial groove is parallel to the axial direction and extends through the multiple annular grooves.

3. The rivet assembly as claimed in claim 1, wherein
the rivet head has an annular flange radially formed to another end of the rivet head facing toward the rivet tube; and
a diameter of the annular flange ranges from 1.05 times to 1.3 times the diameter of the rivet head;
a length of the annular flange ranges from 0.1 times to 0.3 times of an overall length of the rivet head.

4. The rivet assembly as claimed in claim 2, wherein
the rivet head has an annular flange radially formed to another end of the rivet head facing toward the rivet tube; and
a diameter of the annular flange ranges from 1.05 times to 1.3 times the diameter of the rivet head;
a length of the annular flange ranges from 0.1 times to 0.3 times of an overall length of the rivet head.

5. The rivet assembly as claimed in claim 1, wherein
a fixing section is formed between the joining section and the mandrel head;
a diameter of the fixing section is smaller than the diameter of the mandrel head and is larger than a diameter of the joining section;
the diameter of the fixing section corresponds to a diameter of the axial hole of the rivet body;
a tapered portion is formed between the fixing section and the joining section and tapers from the fixing section toward the joining section.

6. The rivet assembly as claimed in claim 2, wherein
a fixing section is formed between the joining section and the mandrel head;
a diameter of the fixing section is smaller than the diameter of the mandrel head is larger than a diameter of the joining section;
the diameter of the fixing section corresponds to a diameter of the axial hole of the rivet body;
a tapered portion is formed between the fixing section and the joining section and tapers from the fixing section toward the joining section.

7. The rivet assembly as claimed in claim 1, wherein a taper angle formed between diametrically opposite sides of the reverse tapered surface of the pull section ranges from 60 to 24°.

8. The rivet assembly as claimed in claim 2, wherein a taper angle formed between diametrically opposite sides of the reverse tapered surface of the pull section ranges from 6° to 24°.

9. The rivet assembly as claimed in claim 1, wherein
a neck section is formed between the joining section and the pull section of the mandrel shank of the mandrel;
the neck section tapers from the joining section toward the pull section; and
a minor diameter of the neck section is smaller than a diameter of the joining section and is substantially equal to a diameter of an end of the pull section facing toward the joining section.

10. The rivet assembly as claimed in claim 2, wherein
a neck section is formed between the joining section and the pull section of the mandrel shank of the mandrel;
the neck section tapers from the joining section toward the pull section; and
a minor diameter of the neck section is smaller than a diameter of the joining section and is substantially equal to a diameter of an end of the pull section facing toward the joining section.
